(19) United States
(12) Patent Application Publication
(10) Pub. No.: US 2025/0147971 A1
(43) Pub. Date: May 8, 2025

(54) VIRTUAL MATCHING SYSTEM INCORPORATING GENETIC DATA

(71) Applicant: Gattaca Labs, Inc., Boca Raton, FL (US)

(72) Inventors: Kerim ERAVCI, Phoenix, AZ (US); Michael CARBONARA, Boca Raton, FL (US)

(21) Appl. No.: 18/501,916

(22) Filed: Nov. 3, 2023

(51) Int. Cl. G06F 16/2457

(52) U.S. Cl. CPC G06F 16/24578

(57) ABSTRACT

A virtual matching system for matching together users and generating virtual avatars based on genetic data, the system being configured to generate a respective genetic profile for each user based, at least in part, on genetic data, receive one or more desired genetic traits from a user, generate a respective compatibility score ranking a compatibility between the user and the other users, determine a potential partner by identifying which user has a highest compatibility score, and present the potential partner to the user. Additionally, virtual avatars are generated based on genetic data, such that matched users may interact together in a virtual environment.

### FIELD

This disclosure relates to systems and methods for virtual matching systems and platforms. More specifically, the disclosed embodiments relate to virtual matching systems for communication and user interaction.

### INTRODUCTION

Traditional social and dating applications primarily rely on user-provided information and preferences to match individuals together. However, these methods may not consider deeper biological compatibility that could influence long-term relationship success and potential offspring health.

### SUMMARY

The present disclosure provides systems, apparatuses, and methods relating to virtual matching systems incorporating genetic data for communication, compatibility matching, and/or user interaction.

In some examples, the present teachings describe computer implemented methods for matching users together, the methods comprising some or all of the following steps: receiving genetic data from a plurality of users; generating a respective genetic profile for each user based, at least in part, on the respective genetic data; receiving one or more desired genetic traits from a user of the plurality of users; generating a respective compatibility score ranking a compatibility between the user and the other users of the plurality of users based at least on the one or more desired genetic traits and the respective genetic profiles; determining a potential partner by identifying which user has a highest compatibility score; and presenting the potential partner to the user. The present teachings further describe systems, software, and devices operating systems and software that embodies such methods.

Features, functions, and advantages may be achieved independently in various embodiments of the present disclosure, or may be combined in yet other embodiments, further details of which can be seen with reference to the following description and drawings.

### BRIEF DESCRIPTION OF THE DRAWINGS

FIG. 1 is a schematic diagram depicting a virtual matching system in accordance with aspects of the present disclosure.

FIG. 2 is a flow chart depicting steps of an illustrative method for matching users together according to the present teachings.

FIG. 3 is schematic diagram of an illustrative data processing system in accordance with aspects of the present disclosure.

FIG. 4 is a schematic diagram of an illustrative network data processing system in accordance with aspects of the present disclosure.

### DETAILED DESCRIPTION

Various aspects and examples of virtual matching systems incorporating genetic data, as well as related methods, are described below and illustrated in the associated drawings. Unless otherwise specified, a virtual matching system incorporating genetic data in accordance with the present teachings, and/or its various components, may contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed embodiments. The following description of various examples is merely illustrative in nature and is in no way intended to limit the disclosure, its application, or uses. Additionally, the advantages provided by the examples and embodiments described below are illustrative in nature and not all examples and embodiments provide the same advantages or the same degree of advantages.

This Detailed Description includes the following sections, which follow immediately below: (1) Definitions; (2) Overview; (3) Examples, Components, and Alternatives; (4) Advantages, Features, and Benefits; and (5) Conclusion. The Examples, Components, and Alternatives section is further divided into subsections, each of which is labeled accordingly.

### Definitions

The following definitions apply herein, unless otherwise indicated.

“Comprising,” “including,” and “having” (and conjugations thereof) are used interchangeably to mean including but not necessarily limited to, and are open-ended terms not intended to exclude additional, unrecited elements or method steps.

Terms such as “first”, “second”, and “third” are used to distinguish or identify various members of a group, or the like, and are not intended to show serial or numerical limitation.

“AKA” means “also known as,” and may be used to indicate an alternative or corresponding term for a given element or elements.

“Processing logic” describes any suitable device(s) or hardware configured to process data by performing one or more logical and/or arithmetic operations (e.g., executing coded instructions). For example, processing logic may include one or more processors (e.g., central processing units (CPUs) and/or graphics processing units (GPUs)), microprocessors, clusters of processing cores, FPGAs (field-programmable gate arrays), artificial intelligence (AI) accelerators, digital signal processors (DSPs), and/or any other suitable combination of logic hardware.

“Providing,” in the context of a method, may include receiving, obtaining, purchasing, manufacturing, generating, processing, preprocessing, and/or the like, such that the object or material provided is in a state and configuration for other steps to be carried out.

In this disclosure, one or more publications, patents, and/or patent applications may be incorporated by reference. However, such material is only incorporated to the extent that no conflict exists between the incorporated material and the statements and drawings set forth herein. In the event of any such conflict, including any conflict in terminology, the present disclosure is controlling.

### Overview

In general, a virtual matching system incorporating genetic data may comprise either a centralized or a decentralized (e.g., peer-to-peer) system for receiving and analyzing genetic data provided by users to generate a genetic profile. The genetic profile is utilized by the virtual matching system to match the respective user with other users, e.g., based on a provided list of desired traits. In some examples, the virtual matching system may utilize the genetic profiles of users to evaluate potential compatibility, predict potential dominant and recessive genetic and epigenetic expressions in potential offspring, and securely store this data in a database, which may in some cases be a decentralized database.

The virtual matching system includes a user interface for interacting with the system, providing genetic information, selecting desired traits, etc. In some examples, users may provide the system with previously sequenced and/or analyzed genetic data. In some examples, the system may be utilized in conjunction with a genetics lab configured to receive genetic material from the users (e.g., provided in person, shipped to the lab, etc.) and provide suitable genome sequencing and analysis.

The resulting genetic profile including details about the user's genetic traits is integrated into the user's profile on the system. In some examples, the genetic profile includes information about ancestry, recessive/genetic traits, potential personality traits, and/or epigenetics. In some examples, the genetic profile is created using sequencing techniques such as Whole Genome Sequencing (WGS), Whole Exome Sequencing (WES), DNA Genotyping, and/or Autosomal DNA testing. In general, any known or future developed method of extracting genetic traits from a DNA-containing sample may be suitable for use with the present teachings. Furthermore, in some cases, alternatively or in addition to DNA analysis, the present teachings may use protein analysis (i.e., proteomics, as opposed to genomics) to determine one or more health traits for purposes of user compatibility matching.

In some examples, the virtual matching system is configured to store and encrypt user data (such as a genetic and/or proteomic profile) on a distributed database. In some examples, the distributed database utilizes a blockchain-based tokenization system. For example, user data may be minted into a non-fungible token (NFT), such that each unique user is categorized with an NFT containing the user's genetic data, health data, and other personal profile data. Additionally, or alternatively, each user's genetic profile is stored on an internal, private blockchain.

Users are able to select desired traits (e.g., physical, personal, and/or genetic attributes) they are seeking in a match. The virtual matching system includes a matching engine configured to match users together based, at least in part, on the users' genetic profiles, desired traits, other user provided characteristics, and/or system-generated characteristics. In some examples, the matching engine utilizes a machine learning model to improve the effectiveness of match suggestions over time.

In some examples, the matching engine utilizes a genetic compatibility algorithm configured to analyze specific genetic markers. In some examples, the genetic markers analyzed are provided, e.g., by the user(s). In some examples, the genetic markers analyzed are predetermined, e.g., through the use of a trained genetic compatibility model. In some examples, the matching engine is configured to utilize predictions from a genetic and/or epigenetic prediction model, personal preferences, shared interests, user interaction with the system, and user interactions within a shared virtual environment.

According to aspects of the present teachings, a genetic and/or epigenetic prediction model is configured to predict potential dominant and recessive genetic and/or epigenetic expressions in future offspring, e.g., resulting from the combination of genetic data of two users. This model enables users to understand and predict potential genetic characteristics of their children.

An exemplary system provides match suggestions to the user, prioritizing potential partners who score highly on genetic compatibility, potential favorable epigenetic outcomes, and personal preference metrics. Users access a shared virtual environment (e.g., accessible via a personal computer, smartphone, virtual reality (VR) headset, etc.), wherein they can interact with each other and other elements of the virtual environment. In some examples, the user's characteristics within the virtual environment are influenced by their genetic profile. For example, certain appearances, actions, etc., may be available only to users having a specific, corresponding genetic marker in their genetic profile.

The exemplary virtual matching system utilizes the genetic profiles and the matching engine to match users together and provide a means for digital interaction in the virtual environment. Users may communicate together, continue the relationship in the virtual environment together, simulate real-world partnership outcomes (including simulating the genetic makeup of offspring) based on their interactions in this virtual environment, and engage in other relationship and/or communication-based interactions.

Aspects of a virtual matching system incorporating genetic data may be embodied as a computer method, computer system, or computer program product. In some cases, the computer program product may be available (for example) as a personal computer software application, a smartphone software application, and/or a gaming console software application. Accordingly, aspects of the virtual matching system may take the form of an entirely hardware embodiment, an entirely software embodiment (including firmware, resident software, micro-code, and the like), or an embodiment combining software and hardware aspects, all of which may generally be referred to herein as a “circuit,” “module,” or “system.” Furthermore, aspects of the virtual matching system may take the form of a computer program product embodied in a computer-readable medium (or media) having computer-readable program code/instructions embodied thereon.

Any combination of computer-readable media may be utilized. Computer-readable media can be a computer-readable signal medium and/or a computer-readable storage medium. A computer-readable storage medium may include an electronic, magnetic, optical, electromagnetic, infrared, and/or semiconductor system, apparatus, or device, or any suitable combination of these. More specific examples of a computer-readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, and/or any suitable combination of these and/or the like. In the context of this disclosure, a computer-readable storage medium may include any suitable non-transitory, tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, and/or any suitable combination thereof. A computer-readable signal medium may include any computer-readable medium that is not a computer-readable storage medium and that is capable of communicating, propagating, or transporting a program for use by or in connection with an instruction execution system, apparatus, or device.

Program code embodied on a computer-readable medium may be transmitted using any appropriate medium, including but not limited to wireless, wireline, optical fiber cable, RF, and/or the like, and/or any suitable combination of these.

Computer program code for carrying out operations for aspects of the virtual matching system may be written in one or any combination of programming languages, including an object-oriented programming language (such as Java, C++), conventional procedural programming languages (such as C), and functional programming languages (such as Haskell). Mobile apps may be developed using any suitable language, including those previously mentioned, as well as Objective-C, Swift, C#, HTML5, and the like. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), and/or the connection may be made to an external computer (for example, through the Internet using an Internet Service Provider).

Aspects of the virtual matching system may be described below with reference to flowchart illustrations and/or block diagrams of methods, apparatuses, systems, and/or computer program products. Each block and/or combination of blocks in a flowchart and/or block diagram may be implemented by computer program instructions. The computer program instructions may be programmed into or otherwise provided to processing logic (e.g., a processor of a general purpose computer, special purpose computer, field programmable gate array (FPGA), or other programmable data processing apparatus) to produce a machine, such that the (e.g., machine-readable) instructions, which execute via the processing logic, create means for implementing the functions/acts specified in the flowchart and/or block diagram block(s).

Additionally or alternatively, these computer program instructions may be stored in a computer-readable medium that can direct processing logic and/or any other suitable device to function in a particular manner, such that the instructions stored in the computer-readable medium produce an article of manufacture including instructions which implement the function/act specified in the flowchart and/or block diagram block(s).

The computer program instructions can also be loaded onto processing logic and/or any other suitable device to cause a series of operational steps to be performed on the device to produce a computer-implemented process such that the executed instructions provide processes for implementing the functions/acts specified in the flowchart and/or block diagram block(s).

Any flowchart and/or block diagram in the drawings is intended to illustrate the architecture, functionality, and/or operation of possible implementations of systems, methods, and computer program products according to aspects of the virtual matching system. In this regard, each block may represent a module, segment, or portion of code, which comprises one or more executable instructions for implementing the specified logical function(s). In some implementations, the functions noted in the block may occur out of the order noted in the drawings. For example, two blocks shown in succession may, in fact, be executed substantially concurrently, or the blocks may sometimes be executed in the reverse order, depending upon the functionality involved. Each block and/or combination of blocks may be implemented by special purpose hardware-based systems (or combinations of special purpose hardware and computer instructions) that perform the specified functions or acts.

### Examples, Components, and Alternatives

The following sections describe selected aspects of illustrative virtual matching systems incorporating genetic data as well as related systems and/or methods. The examples in these sections are intended for illustration and should not be interpreted as limiting the scope of the present disclosure. Each section may include one or more distinct embodiments or examples, and/or contextual or related information, function, and/or structure.

### A. Illustrative Virtual Matching System Incorporating Genetic Data

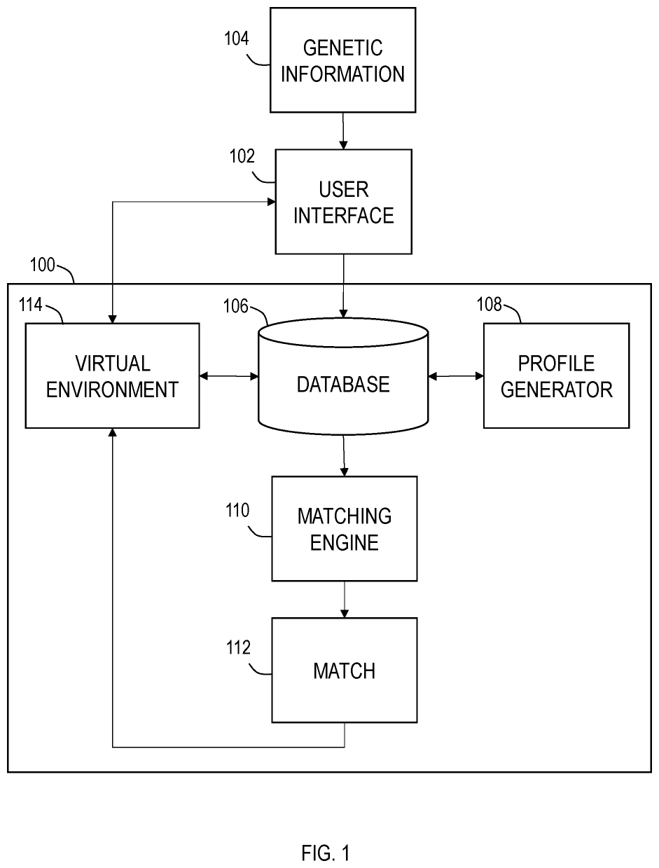

As shown in FIG. 1, this section describes an illustrative virtual matching system 100. System 100 is an example of the more generalized virtual matching system described above.

As with the virtual matching system described above, virtual matching system 100 is configured to receive and analyze genetic data corresponding to each user to generate a personalized, respective genetic profile. The genetic profile is utilized by virtual matching system 100 for engaging with a virtual environment and matching the respective user with other users, e.g., based on a provided list of desired traits, which may include one or more genetic traits. In some examples, the virtual matching system may utilize the genetic profiles of users to evaluate potential compatibility, predict potential dominant and recessive genetic and epigenetic expressions in potential offspring, and securely store the data in a decentralized database.

With continued reference to FIG. 1, a user interface 102 is utilized by users to engage with aspects of system 100. For example, a user may utilize user interface 102 to provide genetic information 104 to system 100. In some examples, genetic information 104 may comprise previously sequenced and/or analyzed genetic data. For example, genetic information 104 may comprise a text-based file including genetic data, such as nucleotide sequences encoded in a FASTA file, genetic data stored in a tab-separated value (TSV) file, or other digital filetype suitable for encoding and/or represented genetic data. In some examples, genetic information may be encrypted and provided to user interface 102 via a secure portal.

Additionally, or alternatively, the user may provide genetic material, e.g., blood, sample/tissue, saliva, etc., for analysis and/or sequencing. For example, the system may be utilized in conjunction with a genetics laboratory configured to receive the genetic material from the user (e.g., provided in person, shipped to the lab, etc.) and provide suitable genome sequencing and analysis. In such examples, genetic information 104 may be provided to system 100 directly from the genetics laboratory.

The data provided to system 100 via user interface 102 is stored in a database 106. Database 106 is configured to store and encrypt user data (such as genetic information 104, among other data), and generally speaking, any data storage mechanism capable of fulfilling these functions may be suitable for use in conjunction with the present teachings. In some examples, database 106 is configured to be a central database, i.e., configured to be implemented on a single (or several) central server(s). In some examples, database 106 is implemented as a distributed database, comprising a network of interconnected servers or nodes, such that data is partitioned and distributed across the multiple nodes. In some examples, database 106 comprises a peer-to-peer storage system (such as the InterPlanetary File System (IPFS)), such that data is redundantly distributed across a network of nodes, thereby providing resilience against node failures and/or network disruptions.

In some examples, database 106 is a distributed database configured to utilize an underlying distributed ledger for storing and confirming user data stored thereon. For example, database 106 may utilize a blockchain-based tokenization system. In such examples, user data such as genetic information 104 and other data generated by system 100, as described in more depth below, may be minted into a non-fungible token (NFT), such that each user's genetic profile is represented by and stored in the NFT.

Genetic information 104 is provided or transmitted from database 106 to a profile generator 108 configured to generate a unique genetic profile for each user based on the provided genetic information. The genetic profile (AKA genome profile) is integrated into the user's profile on system 100, which may be more comprehensive than the genetic profile, i.e., the user's profile may contain additional user information, user characteristics, and/or user preferences that are not based on genetic information.

The genetic profile created by profile generator 108 may include comprehensive data on the user's genetic traits, including information about ancestry, dominant and recessive genetic traits, potential personality traits, and/or epigenetics markers, each of which will be described in more depth below. In some examples, the profile generator utilizes genetic analysis/DNA genotyping techniques such as Whole Genome Sequencing (WGS), Whole Exome Sequencing (WES), and/or Autosomal DNA testing. Each user's genetic profile is stored on database 106 for use within system 100.

Profile generator 108 may analyze the user's ancestry, thereby providing information about the user's lineage and ethnic background in their genetic profile. For example, profile generator 108 may compare the user's genetic data with reference datasets from various global populations to assign one or more weighted values corresponding to ancestry, such as the user's fractional ancestry relative to established geographic or ethnic ancestry groups.

Profile generator 108 may analyze the user's dominant and recessive traits, thereby providing insights into potential genetic expression in offspring, such as health risks and/or other physical characteristics. In some examples, this may include predicting and/or analyzing probabilities of disease expression, e.g., based on the presence of certain genetic markers. Accordingly, profile generator 108 may assign the user a polygenic risk score, or a set of scores wherein the actual risk score is contingent upon information contained in the genetic profile of the user's proposed choice of partners. Additionally, or alternatively, profile generator 108 may analyze physical characteristics/traits of the user's offspring based on genetic information 104, e.g., eye color, hair color, etc. as well as potential personality traits and other genetically inferable traits. Again, the final analysis may further depend upon genetic information from the user's proposed choice of partners.

In some examples, profile generator 108 may analyze epigenetic changes, such as DNA methylation patterns retained in the genetic information. DNA methylation profiling may include analyzing chromosomal loci or specific regions associated with age, diabetes, etc. In some examples, this may include whole genome bisulfite sequencing, enzymatic methyl-sequencing, and/or reduced representation bisulfite sequencing for specific loci. In some examples, epigenetic changes may be analyzed in conjunction with user-supplied answers to a questionnaire about environmental factors and lifestyle choices. In some examples, profile generator 108 may utilize histone analysis and/or karyotype mapping (AKA karyotyping) to further analyze and generate the user's genetic profile.

System 100 is configured to utilize the generated genetic profile to create an in-game (i.e., in-system) profile for accessing other components of the virtual matching system. The generated profile is stored on database 106.

Users are able to choose what physical appearance, personality, and/or genetic traits they are seeking in a match in the form of desired traits. Users are able to select and/or provide the desired traits they are seeking in a potential partner to system 100 via user interface 102. Accordingly, system 100 includes a matching engine 110 that may be configured to match users together based on some combination of their respective genetic profiles and desired traits.

System 100 provides genetic profile data to matching engine 110 relating to each user's genetic profile (e.g., each instance of genetic profile generated for each user). Matching engine 110 is configured to match each user to one or more other users, referred to as a match 112. In other words, after generating a genetic profile for each user, system 100 is configured to search all other genetic profiles and return match 112 (or a list of potential matches 112).

In some examples, matching engine 110 utilizes a vector search algorithm (e.g., k-nearest neighbor (KNN) search, approximate nearest neighbor (ANN) search, a tree search, and/or other suitable vector search algorithm) to search for one or more closest matching user profiles for a given user profile. Matching engine 110 may utilize a plurality of relevant data fields to search for a match. In some examples, the data fields include desired trait keywords, a system-generated compatibility score based on genetic compatibility, and/or historical matches.

Matching engine 110 may utilize one or more Boolean tags for including or excluding users from the matching engine. For example, matching engine 110 may utilize an “availability” tag (thereby adding or removing the profile from the search results) and/or a “local match only” tag (thereby only including the profile in searches pertaining to the same locality). Any other characteristic may be the subject of a Boolean tag, such as gender, age range, education, and so forth.

In some examples, each data field utilized by matching engine 110 may be weighted, e.g., such that certain data fields contribute more to the resulting search results than other data fields. For example, desired traits may be weighted higher than the genetic compatibility score and thus contribute more to the search results. Furthermore, a user may provide the matching engine with a desired weighting for each data field. For example, a user may decide that genetic compatibility is their most important consideration in a match, and thus set the genetic compatibility weight higher than the other data fields.

The desired traits may comprise one or more search fields including an ancestry type, physical traits, personality traits, genetic traits, etc. Some search fields may be provided directly by the user, such as desired genetic traits and desired personality traits. Other search fields may be calculated by system 100, such as a genetic compatibility score. In some examples, the above-described search fields may comprise vectorized values.

The genetic compatibility score is calculated by the matching engine from the genetic data of the two respective users and comparing specific genetic markers known to contribute to genetic compatibility. For example, the genetic compatibility score may be based on predicted physical attraction, e.g., based on pheromone genes, immune system compatibility, e.g., based on major histocompatibility complex (MHC) of genes, potential health risks in offspring, e.g., based on recessive gene pairing, and other suitable compatibility markers.

In addition to these factors, system 100 may also consider non-genetic factors such as shared interests and values, communication styles, lifestyle preferences and long-term life goals, to arrive at an overall compatibility score that may differ from the genetic compatibility score. This holistic approach ensures that matches are not only genetically compatible but also compatible in terms of personality and lifestyle.

In some examples, the matching engine utilizes a genetic compatibility algorithm configured to analyze specific genetic markers. In some examples, the genetic markers analyzed are provided, e.g., by the user(s). In some examples, the genetic markers analyzed are predetermined, e.g., through the use of a trained genetic compatibility model. In some examples, the matching engine is configured to utilize predictions from a genetic and/or epigenetic prediction model, personal preferences, shared interests, user interaction with the system, and user interactions within a shared virtual environment.

In some examples, the genetic compatibility algorithm may attribute a weighted value to one or more genetic attributes utilized in determining compatibility. For examples, positive compatibility markers, such as predicted immune system compatibility, may contribute positively to genetic compatibility. In contrast, negative compatibility markers, such as an increased likelihood to transmit a disease predisposition to offspring, may contribute negatively to genetic compatibility.

Additionally, or alternatively, a genetic/epigenetic prediction model may be utilized by the matching engine. The prediction model is configured to predict potential dominant and recessive genetic and/or epigenetic expressions in future offspring, e.g., resulting from the combination of genetic data of two users. This model enables users to understand and predict potential genetic characteristics of their hypothetical children.

The matching engine may utilize a machine learning model, e.g., to determine a genetic compatibility score, determine a generalized compatibility score, determine a genetic/epigenetic prediction, and/or to improve the effectiveness of match suggestions over time. For example, the matching engine may take into account historic results of the genetic compatibility algorithm, historic predictions from the epigenetic prediction model, personal preferences, interests and historical user behavior in the system, and/or any other desired machine learning factor(s) to better match users together.

Users may access virtual environment 114, e.g., via a personal computer, smartphone, virtual reality (VR) headsets, etc. Within virtual environment 114, users may interact with other users, such as match 112, and various elements of the virtual environment. In some examples, virtual environment 114 includes one or more virtual activities (e.g., structured conversations, mini-games, etc.).

The user's virtual characteristics within the environment may be influenced by their genetic profile. For instance, certain appearances, actions, customized virtual avatars, etc., may be available only to certain users having unique corresponding genetic marker(s) in their genetic profile. For example, each user may have a customized, virtual avatar having a unique appearance and/or set of possible actions/interactions based at least in part on their personal genetic traits. In addition to appearances and actions, users may also have personalized in-game attributes and/or statistics determined or influenced by their genetic data.

Accordingly, each user's genetic profile may be utilized to create a virtual avatar having physical traits (e.g., height, eye color, hair color), predispositions towards certain skills (like athleticism or musical ability), health-related attributes (like stamina or strength), and/or other characteristics informed by their genetic data.

As an illustrative example, the physical appearance of a user's virtual avatar, such as height, eye color, hair color, body type, etc.) may be influenced by their genetic traits associated with these physical characteristics. Furthermore, the user's genetic data might suggest a predisposition towards certain skills, such as genes associated with physical coordination could translate into virtual athletic skills, and genes associated with pattern recognition and/or intelligence could translate into virtual in-game abilities. Additionally, the user's virtual health/energy levels could be influenced by the user's genetic data related to metabolism and physical endurance.

In some examples, users may simulate the genetic makeup of potential offspring produced with their match within the virtual environment. For example, system 100 may utilize a genetic inheritance model, e.g., based on Mendelian inheritance, Punnett squares, DNA recombination, etc., to simulate the genetic makeup of offspring. Accordingly, virtual avatars of the simulated offspring may be presented to the user for interaction within the virtual environment. The abilities and behavioral characteristics of the simulated offspring also may be based at least partially on their genetic makeup, as determined at least partially by the genetic makeup of the users corresponding to their virtual parents.

Users can communicate with their match 112 within this environment and engage in virtual activities together, thereby fostering a virtual relationship. Additionally, they may simulate a real-world partnership based on their interactions within this virtual environment, e.g., by spending time in a virtual home together.

Accordingly, virtual matching system 100 provides genetic analysis, relationship matching, and a virtual environment for interaction. This enables users to meet potential matches, build relationships, simulate offspring based on genetic compatibility, and/or choose to meet in person to build a real-world relationship.

### B. Illustrative Method

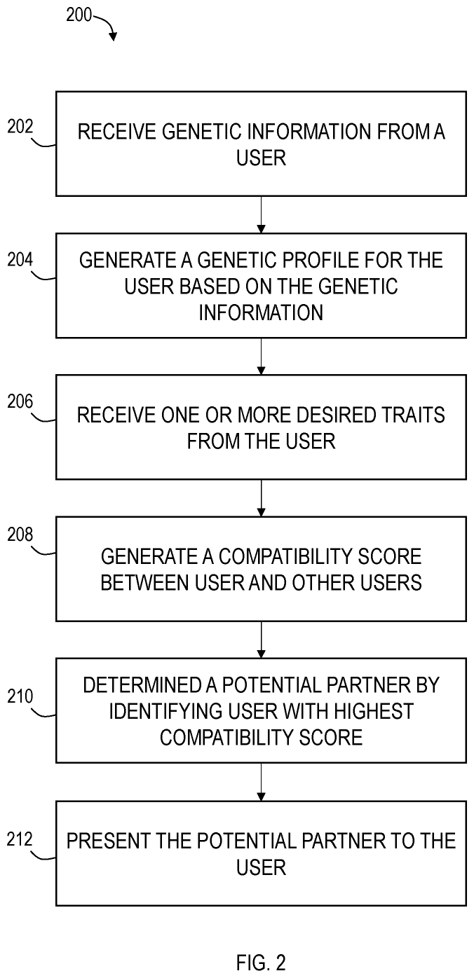

This section describes steps of an illustrative method 200 for matching users together based on genetic data and virtual interactions; see FIG. 2. Aspects of the virtual matching system described above may be utilized in the method steps described below. Where appropriate, reference may be made to components and systems that may be used in carrying out each step. These references are for illustration, and are not intended to limit the possible ways of carrying out any particular step of the method.

FIG. 2 is a flowchart illustrating steps performed in an illustrative method, and may not recite the complete process or all steps of the method. Although various steps of method 200 are described below and depicted in FIG. 2, the steps need not necessarily all be performed, and in some cases may be performed simultaneously or in a different order than the order shown.

Step 202 of method 200 includes receiving genetic information from a user. In some examples, the genetic data comprises a respective sequenced genome corresponding to each user of the plurality of users. The respective sequenced genome may be sequenced via whole genome sequencing, whole exome sequencing, or any other suitable known or future-developed sequencing method. The user's genetic information may be provided or gleaned in any suitable manner, and future technologies again may allow simplified ways of doing this.

Step 204 of method 200 includes generating a genetic profile for the user based on the genetic information provided in step 202. In some examples, the genetic profile includes autosomal DNA testing data, one or more recessive traits, one or more dominant traits, and/or ancestry data. In some examples, the genetic profile includes epigenetic data, e.g., determined by DNA methylation patterns determined via bisulfite sequencing. In some examples, the epigenetic data is determined at least in part by user-supplied answers to a questionnaire on environmental factors and/or lifestyle choices.

Step 206 of method 200 includes receiving one or more desired traits from the user, meaning traits the user is seeking in a partner. In some examples, the desired traits comprise one or more of the following: desired ancestry data, one or more desired recessive traits, and/or one or more desired dominant traits, desired physical appearance(s), and/or desired personality traits. Gender, age range, race, education level, and the like also may be provided as desired traits.

Step 208 of method 200 includes generating a respective compatibility score ranking a compatibility between the user and other users based at least on the one or more desired traits and the respective genetic profiles. In some examples, the compatibility score is determined at least in part by determining a probability of passing on one or more inheritable diseases to offspring based on the respective genetic data. In some examples, the compatibility score is determined at least in part by immune system compatibility, e.g., determined by analyzing a major histocompatibility complex of genes for each user.

In some instances, the compatibility score is primarily or entirely a genetic compatibility score. In other instances, the compatibility score is primarily a non-genetic compatibility score, i.e., the compatibility score focuses on other measures of compatibility and only considers genetic compatibility to a relatively minor degree, such as flagging or ruling out potential matches based on a predetermined threshold probability of severe genetic incompatibility, such as offspring with a serious medical condition.

Step 210 of method 200 includes determining a potential partner by identifying which user has the highest compatibility score. This step may further include determining one or more additional potential partners having lesser compatibility scores that nevertheless exceed some minimum threshold score.

Step 212 of method 200 includes presenting the potential partner to the user. This step may further include providing a list of two or more potential partners to the user, for example in order of descending compatibility scores.

### C. Illustrative Data Processing System

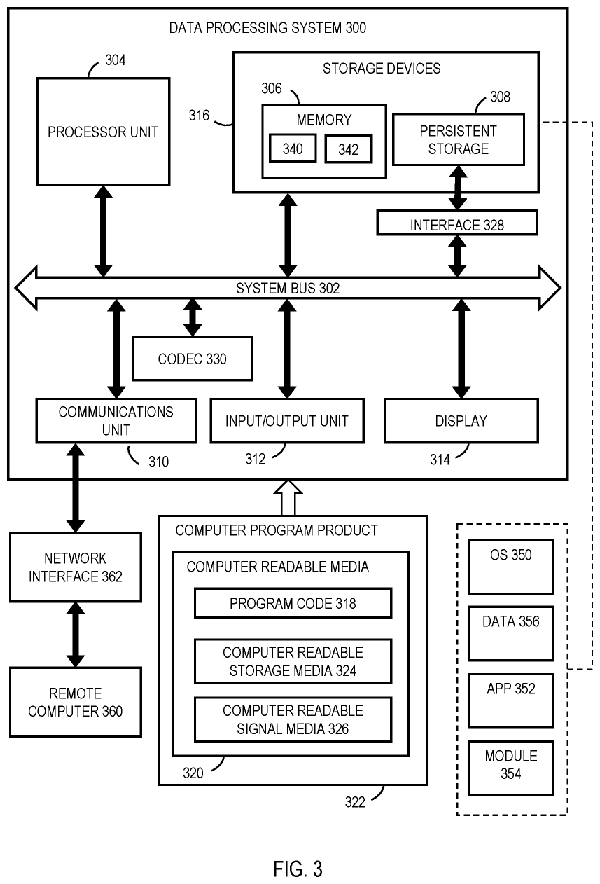

As shown in FIG. 3, this example describes a data processing system 300 (also referred to as a computer, computing system, and/or computer system) in accordance with aspects of the present disclosure. In this example, data processing system 300 is an illustrative data processing system suitable for implementing aspects of the virtual matching systems and methods described above. More specifically, in some examples, devices that are embodiments of data processing systems (e.g., smartphones, tablets, personal computers) may be utilized to access the user interfaces described above, to host the databases described above, and/or to implement one or more of the computer implemented systems and/or methods described above.

In this illustrative example, data processing system 300 includes a system bus 302 (also referred to as communications framework). System bus 302 may provide communications between a processor unit 304 (also referred to as a processor or processors), a memory 306, a persistent storage 308, a communications unit 310, an input/output (I/O) unit 312, a codec 330, and/or a display 314. Memory 306, persistent storage 308, communications unit 310, input/output (I/O) unit 312, display 314, and codec 330 are examples of resources that may be accessible by processor unit 304 via system bus 302.

Processor unit 304 serves to run instructions that may be loaded into memory 306. Processor unit 304 may comprise a number of processors, a multi-processor core, and/or a particular type of processor or processors (e.g., a central processing unit (CPU), graphics processing unit (GPU), etc.), depending on the particular implementation. Further, processor unit 304 may be implemented using a number of heterogeneous processor systems in which a main processor is present with secondary processors on a single chip. As another illustrative example, processor unit 304 may be a symmetric multi-processor system containing multiple processors of the same type.

Memory 306 and persistent storage 308 are examples of storage devices 316. A storage device may include any suitable hardware capable of storing information (e.g., digital information), such as data, program code in functional form, and/or other suitable information, either on a temporary basis or a permanent basis.

Storage devices 316 also may be referred to as computer-readable storage devices or computer-readable media. Memory 306 may include a volatile storage memory 340 and a non-volatile memory 342. In some examples, a basic input/output system (BIOS), containing the basic routines to transfer information between elements within the data processing system 300, such as during start-up, may be stored in non-volatile memory 342. Persistent storage 308 may take various forms, depending on the particular implementation.

Persistent storage 308 may contain one or more components or devices. For example, persistent storage 308 may include one or more devices such as a magnetic disk drive (also referred to as a hard disk drive or HDD), solid state disk (SSD), floppy disk drive, tape drive, Jaz drive, Zip drive, flash memory card, memory stick, and/or the like, or any combination of these. One or more of these devices may be removable and/or portable, e.g., a removable hard drive. Persistent storage 308 may include one or more storage media separately or in combination with other storage media, including an optical disk drive such as a compact disk ROM device (CD-ROM), CD recordable drive (CD-R Drive), CD rewritable drive (CD-RW Drive), and/or a digital versatile disk ROM drive (DVD-ROM). To facilitate connection of the persistent storage devices 308 to system bus 302, a removable or non-removable interface is typically used, such as interface 328.

Input/output (I/O) unit 312 allows for input and output of data with other devices that may be connected to data processing system 300 (i.e., input devices and output devices). For example, an input device may include one or more pointing and/or information-input devices such as a keyboard, a mouse, a trackball, stylus, touch pad or touch screen, microphone, joystick, game pad, satellite dish, scanner, TV tuner card, digital camera, digital video camera, web camera, and/or the like. These and other input devices may connect to processor unit 304 through system bus 302 via interface port(s). Suitable interface port(s) may include, for example, a serial port, a parallel port, a game port, and/or a universal serial bus (USB).

One or more output devices may use some of the same types of ports, and in some cases the same actual ports, as the input device(s). For example, a USB port may be used to provide input to data processing system 300 and to output information from data processing system 300 to an output device. One or more output adapters may be provided for certain output devices (e.g., monitors, speakers, and printers, among others) which require special adapters. Suitable output adapters may include, e.g., video and sound cards that provide a means of connection between the output device and system bus 302. Other devices and/or systems of devices may provide both input and output capabilities, such as remote computer(s) 360. Display 314 may include any suitable human-machine interface or other mechanism configured to display information to a user, e.g., a CRT, LED, or LCD monitor or screen, etc.

Communications unit 310 refers to any suitable hardware and/or software employed to provide or facilitate communications with other data processing systems or devices. While communication unit 310 is shown inside data processing system 300, it may in some examples be at least partially external to data processing system 300. Communications unit 310 may include internal and external technologies, e.g., modems (including regular telephone grade modems, cable modems, and DSL modems), ISDN adapters, and/or wired and wireless Ethernet cards, hubs, routers, etc. Data processing system 300 may operate in a networked environment, using logical connections to one or more remote computers 360. A remote computer(s) 360 may include a personal computer (PC), a server, a router, a network PC, a workstation, a microprocessor-based appliance, a peer device, a smart phone, a tablet, another network note, and/or the like. Remote computer(s) 360 typically include many of the elements described relative to data processing system 300. Remote computer(s) 360 may be logically connected to data processing system 300 through a network interface 362 which is connected to data processing system 300 via communications unit 310. Network interface 362 encompasses wired and/or wireless communication networks, such as local-area networks (LAN), wide-area networks (WAN), and cellular networks. LAN technologies may include Fiber Distributed Data Interface (FDDI), Copper Distributed Data Interface (CDDI), Ethernet, Token Ring, and/or the like. WAN technologies include point-to-point links, circuit switching networks (e.g., Integrated Services Digital networks (ISDN) and variations thereon), packet switching networks, and Digital Subscriber Lines (DSL).

Codec 330 may include an encoder, a decoder, or both, comprising hardware, software, or a combination of hardware and software. Codec 330 may include any suitable device and/or software configured to encode, compress, and/or encrypt a data stream or signal for transmission and storage, and to decode the data stream or signal by decoding, decompressing, and/or decrypting the data stream or signal (e.g., for playback or editing of a video). Although codec 330 is depicted as a separate component, codec 330 may be contained or implemented in memory, e.g., non-volatile memory 342.

Non-volatile memory 342 may include read only memory (ROM), programmable ROM (PROM), electrically programmable ROM (EPROM), electrically erasable programmable ROM (EEPROM), flash memory, and/or the like, or any combination of these. Volatile memory 340 may include random access memory (RAM), which may act as external cache memory. RAM may comprise static RAM (SRAM), dynamic RAM (DRAM), synchronous DRAM (SDRAM), double data rate SDRAM (DDR SDRAM), enhanced SDRAM (ESDRAM), and/or the like, or any combination of these.

Instructions for the operating system, applications, and/or programs may be located in storage devices 316, which are in communication with processor unit 304 through system bus 302. In these illustrative examples, the instructions are in a functional form in persistent storage 308. These instructions may be loaded into memory 306 for execution by processor unit 304. Processes of one or more embodiments of the present disclosure may be performed by processor unit 304 using computer-implemented instructions, which may be located in a memory, such as memory 306.

These instructions are referred to as program instructions, program code, computer usable program code, or computer-readable program code executed by a processor in processor unit 304. The program code in the different embodiments may be embodied on different physical or computer-readable storage media, such as memory 306 or persistent storage 308. Program code 318 may be located in a functional form on computer-readable media 320 that is selectively removable and may be loaded onto or transferred to data processing system 300 for execution by processor unit 304. Program code 318 and computer-readable media 320 form computer program product 322 in these examples. In one example, computer-readable media 320 may comprise computer-readable storage media 324 or computer-readable signal media 326.

Computer-readable storage media 324 may include, for example, an optical or magnetic disk that is inserted or placed into a drive or other device that is part of persistent storage 308 for transfer onto a storage device, such as a hard drive, that is part of persistent storage 308. Computer-readable storage media 324 also may take the form of a persistent storage, such as a hard drive, a thumb drive, or a flash memory, that is connected to data processing system 300. In some instances, computer-readable storage media 324 may not be removable from data processing system 300.

In these examples, computer-readable storage media 324 is a non-transitory, physical or tangible storage device used to store program code 318 rather than a medium that propagates or transmits program code 318. Computer-readable storage media 324 is also referred to as a computer-readable tangible storage device or a computer-readable physical storage device. In other words, computer-readable storage media 324 is media that can be touched by a person.

Alternatively, program code 318 may be transferred to data processing system 300, e.g., remotely over a network, using computer-readable signal media 326. Computer-readable signal media 326 may be, for example, a propagated data signal containing program code 318. For example, computer-readable signal media 326 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 318 may be downloaded over a network to persistent storage 308 from another device or data processing system through computer-readable signal media 326 for use within data processing system 300. For instance, program code stored in a computer-readable storage medium in a server data processing system may be downloaded over a network from the server to data processing system 300. The computer providing program code 318 may be a server computer, a client computer, or some other device capable of storing and transmitting program code 318.

In some examples, program code 318 may comprise an operating system (OS) 350. Operating system 350, which may be stored on persistent storage 308, controls and allocates resources of data processing system 300. One or more applications 352 take advantage of the operating system's management of resources via program modules 354, and program data 356 stored on storage devices 316. OS 350 may include any suitable software system configured to manage and expose hardware resources of computer 300 for sharing and use by applications 352. In some examples, OS 350 provides application programming interfaces (APIs) that facilitate connection of different type of hardware and/or provide applications 352 access to hardware and OS services. In some examples, certain applications 352 may provide further services for use by other applications 352, e.g., as is the case with so-called “middleware.” Aspects of present disclosure may be implemented with respect to various operating systems or combinations of operating systems.

The different components illustrated for data processing system 300 are not meant to provide architectural limitations to the manner in which different embodiments may be implemented. One or more embodiments of the present disclosure may be implemented in a data processing system that includes fewer components or includes components in addition to and/or in place of those illustrated for computer 300. Other components shown in FIG. 3 can be varied from the examples depicted. Different embodiments may be implemented using any hardware device or system capable of running program code. As one example, data processing system 300 may include organic components integrated with inorganic components and/or may be comprised entirely of organic components (excluding a human being). For example, a storage device may be comprised of an organic semiconductor.

In some examples, processor unit 304 may take the form of a hardware unit having hardware circuits that are specifically manufactured or configured for a particular use, or to produce a particular outcome or progress. This type of hardware may perform operations without needing program code 318 to be loaded into a memory from a storage device to be configured to perform the operations. For example, processor unit 304 may be a circuit system, an application specific integrated circuit (ASIC), a programmable logic device, or some other suitable type of hardware configured (e.g., preconfigured or reconfigured) to perform a number of operations. With a programmable logic device, for example, the device is configured to perform the number of operations and may be reconfigured at a later time. Examples of programmable logic devices include, a programmable logic array, a field programmable logic array, a field programmable gate array (FPGA), and other suitable hardware devices. With this type of implementation, executable instructions (e.g., program code 318) may be implemented as hardware, e.g., by specifying an FPGA configuration using a hardware description language (HDL) and then using a resulting binary file to (re) configure the FPGA.

In another example, data processing system 300 may be implemented as an FPGA-based (or in some cases ASIC-based), dedicated-purpose set of state machines (e.g., Finite State Machines (FSM)), which may allow critical tasks to be isolated and run on custom hardware. Whereas a processor such as a CPU can be described as a shared-use, general purpose state machine that executes instructions provided to it, FPGA-based state machine(s) are constructed for a special purpose, and may execute hardware-coded logic without sharing resources. Such systems are often utilized for safety-related and mission-critical tasks.

In still another illustrative example, processor unit 304 may be implemented using a combination of processors found in computers and hardware units. Processor unit 304 may have a number of hardware units and a number of processors that are configured to run program code 318. With this depicted example, some of the processes may be implemented in the number of hardware units, while other processes may be implemented in the number of processors.

In another example, system bus 302 may comprise one or more buses, such as a system bus or an input/output bus. Of course, the bus system may be implemented using any suitable type of architecture that provides for a transfer of data between different components or devices attached to the bus system. System bus 302 may include several types of bus structure(s) including memory bus or memory controller, a peripheral bus or external bus, and/or a local bus using any variety of available bus architectures (e.g., Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI)).

Additionally, communications unit 310 may include a number of devices that transmit data, receive data, or both transmit and receive data. Communications unit 310 may be, for example, a modem or a network adapter, two network adapters, or some combination thereof. Further, a memory may be, for example, memory 306, or a cache, such as that found in an interface and memory controller hub that may be present in system bus 302.

### D. Illustrative Distributed Data Processing System

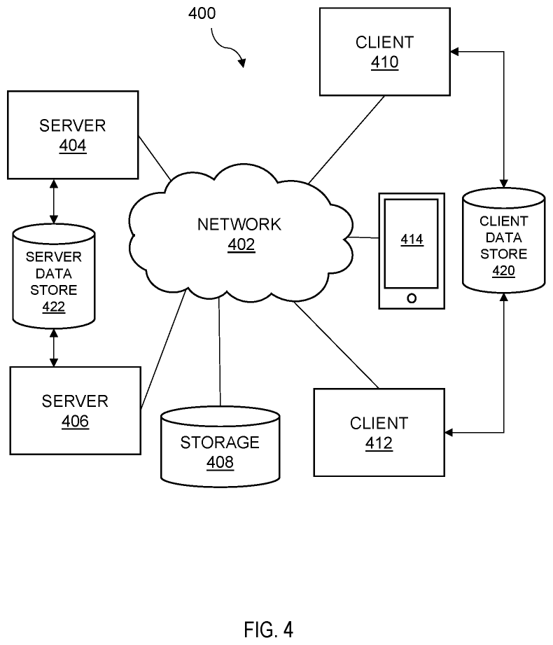

As shown in FIG. 4, this example describes a general network data processing system 400, interchangeably termed a computer network, a network system, a distributed data processing system, or a distributed network, aspects of which may be included in one or more illustrative embodiments of the virtual matching systems described above. For example, communication between the user interface(s) and the database(s) described above may occur through the use of a network data processing system. Additionally, or alternatively, communication between two or more users of the virtual matching system(s) may occur through the use of a network data processing system.

It should be appreciated that FIG. 4 is provided as an illustration of one implementation and is not intended to imply any limitation with regard to environments in which different embodiments may be implemented. Many modifications to the depicted environment may be made.

Network system 400 is a network of devices (e.g., computers), each of which may be an example of data processing system 300, and other components. Network data processing system 400 may include network 402, which is a medium configured to provide communications links between various devices and computers connected within network data processing system 400. Network 402 may include connections such as wired or wireless communication links, fiber optic cables, and/or any other suitable medium for transmitting and/or communicating data between network devices, or any combination thereof.

In the depicted example, a first network device 404 and a second network device 406 connect to network 402, as do one or more computer-readable memories or storage devices 408. Network devices 404 and 406 are each examples of data processing system 300, described above. In the depicted example, devices 404 and 406 are shown as server computers, which are in communication with one or more server data store(s) 422 that may be employed to store information local to server computers 404 and 406, among others. However, network devices may include, without limitation, one or more personal computers, mobile computing devices such as personal digital assistants (PDAs), tablets, and smartphones, handheld gaming devices, wearable devices, tablet computers, routers, switches, voice gates, servers, electronic storage devices, imaging devices, media players, and/or other networked-enabled tools that may perform a mechanical or other function. These network devices may be interconnected through wired, wireless, optical, and other appropriate communication links.

In addition, client electronic devices 410 and 412 and/or a client smart device 414, may connect to network 402. Each of these devices is an example of data processing system 300, described above regarding FIG. 3. Client electronic devices 410, 412, and 414 may include, for example, one or more personal computers, network computers, and/or mobile computing devices such as personal digital assistants (PDAs), smart phones, handheld gaming devices, wearable devices, and/or tablet computers, and the like. In the depicted example, server 404 provides information, such as boot files, operating system images, and applications to one or more of client electronic devices 410, 412, and 414. Client electronic devices 410, 412, and 414 may be referred to as “clients” in the context of their relationship to a server such as server computer 404. Client devices may be in communication with one or more client data store(s) 420, which may be employed to store information local to the clients (e.g., cookie(s) and/or associated contextual information). Network data processing system 400 may include more or fewer servers and/or clients (or no servers or clients), as well as other devices not shown.

In some examples, first client electric device 410 may transfer an encoded file to server 404. Server 404 can store the file, decode the file, and/or transmit the file to second client electric device 412. In some examples, first client electric device 410 may transfer an uncompressed file to server 404 and server 404 may compress the file. In some examples, server 404 may encode text, audio, and/or video information, and transmit the information via network 402 to one or more clients.

Client smart device 414 may include any suitable portable electronic device capable of wireless communications and execution of software, such as a smartphone or a tablet. Generally speaking, the term “smartphone” may describe any suitable portable electronic device configured to perform functions of a computer, typically having a touchscreen interface, Internet access, and an operating system capable of running downloaded applications. In addition to making phone calls (e.g., over a cellular network), smartphones may be capable of sending and receiving emails, texts, and multimedia messages, accessing the Internet, and/or functioning as a web browser. Smart devices (e.g., smartphones) may include features of other known electronic devices, such as a media player, personal digital assistant, digital camera, video camera, and/or global positioning system. Smart devices (e.g., smartphones) may be capable of connecting with other smart devices, computers, or electronic devices wirelessly, such as through near field communications (NFC), BLUETOOTH®, WiFi, or mobile broadband networks. Wireless connectively may be established among smart devices, smartphones, computers, and/or other devices to form a mobile network where information can be exchanged.

Data and program code located in system 400 may be stored in or on a computer-readable storage medium, such as network-connected storage device 408 and/or a persistent storage 308 of one of the network computers, as described above, and may be downloaded to a data processing system or other device for use. For example, program code may be stored on a computer-readable storage medium on server computer 404 and downloaded to client 410 over network 402, for use on client 410. In some examples, client data store 420 and server data store 422 reside on one or more storage devices 408 and/or 308.

Network data processing system 400 may be implemented as one or more of different types of networks. For example, system 400 may include an intranet, a local area network (LAN), a wide area network (WAN), or a personal area network (PAN). In some examples, network data processing system 400 includes the Internet, with network 402 representing a worldwide collection of networks and gateways that use the transmission control protocol/Internet protocol (TCP/IP) suite of protocols to communicate with one another. At the heart of the Internet is a backbone of high-speed data communication lines between major nodes or host computers. Thousands of commercial, governmental, educational and other computer systems may be utilized to route data and messages. In some examples, network 402 may be referred to as a “cloud.” In those examples, each server 404 may be referred to as a cloud computing node, and client electronic devices may be referred to as cloud consumers, or the like. FIG. 4 is intended as an example, and not as an architectural limitation for any illustrative embodiments.

### E. Illustrative Combinations and Additional Examples

This section describes additional aspects and features of a virtual matching system incorporating genetic data, presented without limitation as a series of paragraphs, some or all of which may be alphanumerically designated for clarity and efficiency. Each of these paragraphs can be combined with one or more other paragraphs, and/or with disclosure from elsewhere in this application, in any suitable manner. Some of the paragraphs below expressly refer to and further limit other paragraphs, providing without limitation examples of some of the suitable combinations.
A0. A computer implemented method for matching users together, the method comprising:
receiving genetic data from a plurality of users;
generating a respective genetic profile for each user based, at least in part, on the respective genetic data;
receiving one or more desired genetic traits from a user of the plurality of users;
generating a respective compatibility score ranking a compatibility between the user and the other users of the plurality of users based at least on the one or more desired genetic traits and the respective genetic profiles;
determining a potential partner by identifying which user has a highest compatibility score; and
presenting the potential partner to the user.
A1. The computer implemented method of paragraph A0, wherein the genetic data comprises a respective sequenced genome corresponding to each user of the plurality of users.
A2. The computer implemented method of paragraph A1, wherein each respective sequenced genome is sequenced via whole genome sequencing.
A3. The computer implemented method of paragraph A1, wherein each respective sequenced genome is sequenced via whole exome sequencing.
A4. The computer implemented method of any one of paragraphs A0-A3, wherein each respective genetic profile includes autosomal DNA testing data.
A5. The computer implemented method of any one of paragraphs A0-A4, wherein each respective genetic profile includes one or more recessive traits.
A6. The computer implemented method of any one of paragraphs A0-A5, wherein each respective genetic profile includes one or more dominant traits.
A7. The computer implemented method of any one of paragraphs A0-A6, wherein each respective genetic profile includes ancestry data.
A8. The computer implemented method of any one of paragraphs A0-A7, wherein each respective genetic profile includes epigenetic data.
A9. The computer implemented method of paragraph A8, wherein the epigenetic data is determined at least in part by DNA methylation patterns.
A10. The computer implemented method of paragraph A9, wherein the DNA methylation patterns are determined via bisulfite sequencing.
A11. The computer implemented method of any one of paragraphs A8-A10, wherein epigenetic data is determined at least in part by user-supplied answers to a questionnaire.
A12. The computer implemented method of any one of paragraphs A0-A11, wherein the one or more desired traits include one or more of the following: desired ancestry data, one or more desired recessive traits, and/or one or more desired dominant traits.
A13. The computer implemented method of any one of paragraphs A0-A11, wherein the one or more desired traits include one or more of the following: desired physical appearance and/or desired personality traits.
A13. The computer implemented method of any one of paragraphs A0-A12, wherein each respective compatibility score is determined at least in part by determining a probability of passing on one or more inheritable diseases to offspring based on the respective genetic data of the respective users.
A14. The computer implemented method of any one of paragraphs A0-A13, wherein each respective compatibility score is determined at least in part by immune system compatibility.
A15. The computer implemented method of paragraph A14, wherein immune system compatibility is determined by analyzing a major histocompatibility complex of genes for each user.
A16. The computer implemented method of any one of paragraphs A0-A16, wherein the genetic data of each user is stored on a distributed database.
A17. The computer implemented method of paragraph A16, wherein the distributed database comprises a blockchain network.
A18. The computer implemented method of paragraph A17, wherein the genetic profile of each user is tokenized on the blockchain network as a respective non-fungible token.
A19. The computer implemented method of any one of paragraphs A0-A18, further comprising:
generating a respective virtual avatar for each user; and
wherein presenting the potential partner to the user includes displaying the respective virtual avatar of the user and the potential partner in a virtual environment.
A20. The computer implemented method of paragraph A19, wherein generating the respective virtual avatar for each user includes utilizing one or more genetic traits of the respective genetic data to generate an appearance for the respective virtual avatar.
A21. The computer implemented method of paragraph A20, wherein the one or more genetic traits includes ancestry data.
B0. A data processing system for matching users together, the system comprising:
one or more processors;
a memory; and
a plurality of instructions stored in the memory and executable by the one or more processors to:
   receive genetic data from a plurality of users;
   generate a respective genetic profile for each user based, at least in part, on the respective genetic data;
   receive one or more desired genetic traits from a user of the plurality of users;
   generate a respective compatibility score ranking a compatibility between the user and the other users of the plurality of users based at least on the one or more desired genetic traits and the respective genetic profiles;
   determine a potential partner by identifying which user has a highest compatibility score; and
   present the potential partner to the user.
B1. The data processing system of paragraph B0, wherein the genetic data comprises a respective sequenced genome corresponding to each user of the plurality of users.
B2. The data processing system of paragraph B1, wherein each respective sequenced genome is sequenced via whole genome sequencing.
B3. The data processing system of paragraph B1, wherein each respective sequenced genome is sequenced via whole exome sequencing.
B4. The data processing system of any one of paragraphs B0-B3, wherein each respective genetic profile includes autosomal DNB testing data.
B5. The data processing system of any one of paragraphs B0-B4, wherein each respective genetic profile includes one or more recessive traits.
B6. The data processing system of any one of paragraphs B0-B5, wherein each respective genetic profile includes one or more dominant traits.
B7. The data processing system of any one of paragraphs B0-B6, wherein each respective genetic profile includes ancestry data.
B8. The data processing system of any one of paragraphs B0-B7, wherein each respective genetic profile includes epigenetic data.
B9. The data processing system of paragraph B8, wherein the epigenetic data is determined at least in part by DNB methylation patterns.
B10. The data processing system of paragraph B9, wherein the DNB methylation patterns are determined via bisulfite sequencing.
B11. The data processing system of any one of paragraphs B8-B10, wherein epigenetic data is determined at least in part by user-supplied answers to a questionnaire.
B12. The data processing system of any one of paragraphs B0-B11, wherein the one or more desired traits include one or more of the following: desired ancestry data, one or more desired recessive traits, and/or one or more desired dominant traits.
B13. The data processing system of any one of paragraphs B0-B11, wherein the one or more desired traits include one or more of the following: desired physical appearance and/or desired personality traits.
B13. The data processing system of any one of paragraphs B0-B12, wherein each respective compatibility score is determined at least in part by determining a probability of passing on one or more inheritable diseases to offspring based on the respective genetic data of the respective users.
B14. The data processing system of any one of paragraphs B0-B13, wherein each respective compatibility score is determined at least in part by immune system compatibility.
B15. The data processing system of paragraph B14, wherein immune system compatibility is determined by analyzing a major histocompatibility complex of genes for each user.
B16. The data processing system of any one of paragraphs B0-B16, wherein the genetic data of each user is stored on a distributed database.
B17. The data processing system of paragraph B16, wherein the distributed database comprises a blockchain network.
B18. The data processing system of paragraph B17, wherein the genetic profile of each user is tokenized on the blockchain network as a respective non-fungible token.
B19. The data processing system of any one of paragraphs B0-B18, wherein the plurality of instructions are further configured to:
   generate a respective virtual avatar for each user; and
wherein presenting the potential partner to the user includes displaying the respective virtual avatar of the user and the potential partner in a virtual environment.
B20. The data processing system of paragraph B19, wherein generating the respective virtual avatar for each user includes utilizing one or more genetic traits of the respective genetic data to generate an appearance for the respective virtual avatar.
B21. The data processing system of paragraph B20, wherein the one or more genetic traits includes ancestry data.
C0. A computer implemented method of generating a virtual avatar, the method comprising:
receiving genetic data from a user;
analyzing the genetic data to determine one or more genetic traits of the user; and
generating a virtual avatar by utilizing the determined genetic traits.
C1. The computer implemented method of paragraph C0, wherein the genetic data comprises a sequenced genome of the user.
C2. The computer implemented method of paragraph C1, wherein the sequenced genome is sequenced via whole genome sequencing.
C3. The computer implemented method of paragraph C1, wherein the sequenced genome is sequenced via whole exome sequencing.
C4. The computer implemented method of any one of paragraphs C0-C3, wherein the genetic data includes autosomal DNC testing data.
C5. The computer implemented method of any one of paragraphs C0-C4, wherein the genetic data includes one or more recessive traits.
C6. The computer implemented method of any one of paragraphs C0-C5, wherein the genetic data includes one or more dominant traits.
C7. The computer implemented method of any one of paragraphs C0-C6, wherein the genetic data includes ancestry data.
C8. The computer implemented method of any one of paragraphs C0-C7, wherein the genetic data includes epigenetic data.
C9. The computer implemented method of paragraph C8, wherein the epigenetic data is determined at least in part by DNC methylation patterns.
C10. The computer implemented method of paragraph C9, wherein the DNC methylation patterns are determined via bisulfite sequencing.
C11. The computer implemented method of any one of paragraphs C8-C10, wherein epigenetic data is determined at least in part by user-supplied answers to a questionnaire.
C12. The computer implemented method of any one of paragraphs C0-C11, wherein the genetic data is stored on a distributed database.
C13. The computer implemented method of paragraph C12, wherein the distributed database comprises a blockchain network.
C14. The computer implemented method of paragraph C13, wherein the genetic data is tokenized on the blockchain network as a non-fungible token.
D0. A data processing system for generating a virtual avatar, the system comprising:
one or more processors;
a memory; and
a plurality of instructions stored in the memory and executable by the one or more processors to:
   receive genetic data from a user;
   analyze the genetic data to determine one or more genetic traits of the user;
and
   generate a virtual avatar by utilizing the determined genetic traits.
D1. The data processing system of paragraph D0, wherein the genetic data comprises a sequenced genome of the user.
D2. The data processing system of paragraph D1, wherein the sequenced genome is sequenced via whole genome sequencing.
D3. The data processing system of paragraph D1, wherein the sequenced genome is sequenced via whole exome sequencing.
D4. The data processing system of any one of paragraphs DO-D3, wherein the genetic data includes autosomal DND testing data.
D5. The data processing system of any one of paragraphs DO-D4, wherein the genetic data includes one or more recessive traits.
D6. The data processing system of any one of paragraphs DO-D5, wherein the genetic data includes one or more dominant traits.
D7. The data processing system of any one of paragraphs DO-D6, wherein the genetic data includes ancestry data.
D8. The data processing system of any one of paragraphs DO-D7, wherein the genetic data includes epigenetic data.
D9. The data processing system of paragraph D8, wherein the epigenetic data is determined at least in part by DND methylation patterns.
D10. The data processing system of paragraph D9, wherein the DND methylation patterns are determined via bisulfite sequencing.
D11. The data processing system of any one of paragraphs D8-D10, wherein epigenetic data is determined at least in part by user-supplied answers to a questionnaire.
D12. The computer implemented method of any one of paragraphs DO-D11, wherein the genetic data is stored on a distributed database.
D13. The computer implemented method of paragraph D12, wherein the distributed database comprises a blockchain network.
D14. The computer implemented method of paragraph D13, wherein the genetic data is tokenized on the blockchain network as a non-fungible token.

### Advantages, Features, and Benefits

The different embodiments and examples of the virtual matching system described herein provide several advantages over known solutions for providing users with relationship matches and virtual environment representation. For example, illustrative embodiments and examples described herein allow for enhanced compatibility by considering genetic data in addition to traditional factors, leading to more successful and satisfying relationships.

Additionally, and among other benefits, illustrative embodiments and examples described herein allow for more informed decision-making with respect to relationships. For example, as users are provided with insights into potential genetic outcomes in their offspring, they are able to make more informed decisions about potential relationships.

Additionally, and among other benefits, illustrative embodiments and examples described herein allow users to virtually interact with each other in a unique way, utilizing personal genetics data to cater their experience.

Additionally, and among other benefits, illustrative embodiments and examples described herein allow the ability for users to simulate real-world partnership outcomes (including simulating the genetic makeup of offspring).

Additionally, and among other benefits, illustrative embodiment and examples described herein enable users to have more direct control over what genetic attributes are present in a match.

No known system or device can perform these functions. However, not all embodiments and examples described herein provide the same advantages or the same degree of advantage.

### CONCLUSION

The disclosure set forth above may encompass multiple distinct examples with independent utility. Although each of these has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

1-15. (canceled)

16. A computer implemented method for matching users together, the method comprising:
receiving genetic data corresponding to each of a plurality of users;
generating a genetic profile for each user based, at least in part, on the user's corresponding genetic data;
generating a respective virtual avatar for each user, the generating comprising utilizing user customization selections and one or more genetic traits of the respective genetic data to generate an appearance trait for the respective virtual avatar, and limiting the user customization selections based on the respective genetic data;
generating a compatibility score between a designated user of the plurality of users and each other user of the plurality of users, based at least partially on the genetic profiles, wherein generating the compatibility score comprises determining immunes system compatibility based on analysis of major histocompatibility complex of the genetic profiles of each pair of users;
determining at least one potential partner for the designated user based on the compatibility scores; and
identifying the potential partner to the designated user, displaying the respective virtual avatar of the designated and the potential partner in a virtual environment.

17-19. (canceled)

20. A computer implemented method for determining user compatibility, comprising:
receiving genetic information regarding each of a plurality of users;
generating a genetic profile for each user based on the genetic information;
generating a compatibility score corresponding to each pair of users of the plurality of users, based at least partially on the genetic profiles, wherein generating the compatibility score comprises determining health risks to a potential offspring based on a combination the genetic profiles of each pair of users;
generating a respective virtual avatar for each user, the generating comprising generating an appearance trait for the respective virtual avatar based on user customization selections and the corresponding user's genetic profile, and limiting the user customization selections based on the corresponding user's genetic profile; and
identifying to each user at least one compatible other user, based on the compatibility scores, displaying the virtual avatar of the respective user and the at least one compatible other user in a live virtual environment.

21. The computer implemented method of claim 16, wherein the appearance trait is height.

22. The computer implemented method of claim 16, wherein the appearance trait is selected from the group consisting of eye color and hair color.

23. The computer implemented method of claim 16, wherein the appearance trait is a body type.

24. The computer implemented method of claim 20, wherein the appearance trait is height.

25. The computer implemented method of claim 20, wherein the appearance trait is eye color.

26. The computer implemented method of claim 20, wherein the appearance trait is hair color.

27. The computer implemented method of claim 20, wherein the appearance trait is a body type.

28-38. (canceled)

39. (canceled)

40. A computer implemented method for determining user compatibility, comprising:
receiving genetic information regarding each of a plurality of users;
generating a genetic profile for each user based on the genetic information;
generating a compatibility score corresponding to each pair of users of the plurality of users, based at least partially on the genetic profiles;
generating a respective virtual avatar for each user, the generating comprising generating an appearance trait for the respective virtual avatar based on user customization selections and the corresponding user's genetic profile, and limiting the user customization selections based on the corresponding user's genetic profile; and
identifying to each user at least one compatible other user, based on the compatibility scores, displaying the virtual avatar of the respective user and the at least one compatible other user in a virtual environment, wherein displaying the virtual avatar of the respective user and the at least one compatible other user in the virtual environment comprises displaying an offspring avatar generated based on a combination the genetic profiles of the respective user and the at least one compatible other user.

41. The computer implemented method of claim 20, wherein generating the compatibility score comprises determining immunes system compatibility based on analysis of major histocompatibility complex of the genetic profiles of each pair of users.
